(19) United States
(12) Patent Application Publication
(10) Pub. No.: US 2007/0279021 A1
(43) Pub. Date: Dec. 6, 2007

(54) Power Supply Circuit, Charge Pump Circuit, and Portable Appliance Therewith

(75) Inventors: Osamu Yanagida, Kyoto (JP); Yoshinori Imanaka, Kyoto (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/722,932

(22) PCT Filed: Oct. 17, 2005
(86) PCT No.: PCT/JP05/19051

§ 371 Date: Jun. 27, 2007

(30) Foreign Application Priority Data
Dec. 28, 2004 (JP) 2004-378601

(51) Int. Cl. G05F 1/00

(52) U.S. Cl. 323/272

(57) ABSTRACT

According to the invention, a charge pump circuit (21) has, as switching means turned on when a capacitor (C1) is charged, transistors (P1 to P3) connected in parallel between one end of the capacitor (C1) and an input terminal (T1). When the capacitor (C1) is charged, a controller (CNT) determines which of the transistors (P1 to P3) to drive based on the results of monitoring of the input and output voltages by first and second detectors (DET1, DET2). Thus, even if the level of the input voltage varies, it is possible to reduce in-rush current at start-up without causing a drop in the output voltage or a loss in efficiency.

### TECHNICAL FIELD

The present invention relates to a charge pump circuit used as a DC/DC converter (in particular one used as battery output converting means in a portable apparatus).

### BACKGROUND ART

FIG. 8 is a circuit diagram showing a conventional example of a charge pump circuit. The charge pump circuit shown in this figure is so configured as to turn on and off switches SW1 to SW4 cyclically in such a way that a first capacitor C1 is charged with an input voltage Vin fed in via an input terminal and that the charge voltage across the first capacitor C1 is then fed out via an output terminal as a negative voltage Vout (−Vin).

More specifically, here, the negative voltage is outputted in the following manner. First the switches SW1 and SW2 are turned on and the switches SW3 and SW4 are kept off. As a result of this switching, the input voltage Vin is applied via the switch SW1 to a first end (point A) of the first capacitor C1, and a second end (point B) of the first capacity C1 is grounded via the switch SW2. Thus the first capacitor C1 is charged until the potential difference across it becomes equal to the input voltage Vin.

After completion of the charging of the first capacitor C1, now the switches SW1 and SW2 are turned off and the switches SW3 and SW4 are turned on. As a result of this switching, point A is grounded via the switch SW3, and thus the potential at point A falls from the input voltage Vin to the ground potential. Here, since the voltage across the first capacitor C1 is approximately equal to the input voltage Vin as a result of the previous charging, the just mentioned fall in the potential at point A causes the potential at point B to fall from the ground voltage to a negative voltage −Vin.

Here, since point B conducts via the switch SW4 to the output terminal, the electric charge in the first capacitor C1 moves to a second capacitor C2, and this causes the potential at the output terminal to fall to −Vin.

One problem with this charge pump circuit is in-rush current at start-up. In particular in a system having a high-impedance power supply section as in a portable appliance operating from a battery as its power source, an in-rush current disadvantageously causes a drop in the voltage supplied to different parts of the appliance and thereby destabilizes its operation.

One conventionally disclosed and proposed technology overcomes the above problem in the following manner. The connection path between a supplied voltage and a capacitor is turned on and off with an FET (field-effect transistor), and the gate drive voltage of this FET is varied according to the charge voltage across the capacitor with a gate drive voltage varying circuit. Here, the higher the charge voltage is, the higher the gate drive voltage of the FET is made and, the lower the charge voltage is, the lower the gate drive voltage of the FET is made so that the on-state resistance of the FET is increased and decreased whenever necessary. This makes it possible to reduce in-rush current (for example, see Patent Document 1 listed below).

Another conventionally disclosed and proposed technology overcomes the above problem in the following manner. The charging and discharging of a capacitor is controlled by turning on and a plurality of transistors, of which a predetermined one has, connected in parallel with it, a switching device that has a higher on-state resistance that in. For a predetermined period after the start of supply of a direct-cu rent voltage, the predetermined transistor is kept off and the charging and discharging of the capacitor are controlled with the switching device connected in parallel with it; after the lapse of the predetermined period, the charging and discharging of the capacitor are controlled with the predetermined transistor. This too makes it possible to reduce in-rush current (for example, see Patent Document 2 listed below).
Patent Document 1: JP-A-H10-014218
Patent Document 2: JP-A-2004-048893

### DISCLOSURE OF THE INVENTION

### Problems to be Solved by the Invention

Certainly, with either of the conventional technologies described above, it is possible to reduce in-rush current.

Inconveniently, however, these conventional technologies have the following disadvantages. The technology of Patent Document 1 adopts a circuit configuration such that, when the FET provided in the connection path between the supply voltage and the capacitor is turned off, the gate drive voltage of the FET is pulled up to the input voltage Vin via a resistor. Thus the turning-off of the FET is accompanied with a delay caused by the CR time constant circuit formed by the gate capacitance and gate resistance, resulting in a drop in the output voltage and a loss in efficiency. In particular in a case where the FET is given a high W/L ratio (the ratio of gate width to gate length), it naturally has a high capacitance, and thus makes the just mentioned disadvantage more noticeable. Thus the technology of Patent Document 1 is not suitable for charge pump circuits having low output impedances. For the same reason as stated above, the technology of Patent Document 1 is not suitable either for adaptation to higher switching frequencies.

On the other hand, the technology of Patent Document 2 simply offers a configuration where, only for a predetermined period after the start of supply of a direct-current voltage, instead of a switching device for steady use, a switching device for start-up is used that has higher on-state resistance. Thus Patent Document 2 does not give any consideration to variation in the input voltage. For example, when the technology of Patent Document 2 is applied to a charge pump circuit used as battery output converting means in a portable appliance, although the risk of in-rush current diminishes as the battery drains, the switching device for start-up retains its high on-state resistance for coping with the full-charged battery level (the maximum input voltage). Thus, though adequate with the fully charged battery, the on-state resistance eventually becomes excessively high as the battery drains, causing a drop in the output voltage and a loss in efficiency.

An object of the present invention is to provide a power supply circuit, a charge pump circuit, and a portable apparatus incorporating them with which, even if the level of the input voltage varies, it is possible to reduce in-rush current at start-up without causing a drop in the output voltage or a loss in efficiency.

### Means for Solving the Problem

To achieve the above object, according to one aspect of the present invention, in a power supply circuit
that is provided with: first switching means connected between a first end of a capacitor and an input voltage input terminal and turned on when the capacitor is charged; and/or second switching means connected between a second end of the capacitor and a reference voltage input terminal and turned on when the capacitor is charged, and
that produces a desired output voltage from an input voltage by charging and discharging the capacitor cyclically,
at least one of the first and second switching means
comprises a plurality of divided transistors connected in parallel with one another and having different driving capacities and
is so controlled as to yield a minimum driving capacity when the input voltage is high and the output voltage is low and a maximum driving capacity when the input voltage is low and the output voltage is stable (a first configuration).

According to another aspect of the present invent ion, in a charge pump circuit
that is provided with: first switching means connect d between a first end of a first capacitor and an input voltage input terminal and turned on when the capacitor is charged; second switching means connected between a second end of the first capacitor and a reference voltage input terminal and turned on when the capacitor is charged; controlling means controlling the driving of the first and second switching means; first monitoring means monitoring an input voltage; and second monitoring means monitoring an output voltage, and
that produces a desired output voltage from the input voltage by charging and discharging the first capacitor cyclically,
at least one of the first and second switching means is divided into a plurality of divided transistors connected in parallel with one another, and
when the first capacitor is charged, the controlling means determines which of the plurality of divided transistors to drive based on the result of monitoring by the first and second monitoring means (a second configuration).

The charge pump circuit having the second configuration described above may be further provided with: third and fourth switching means turned on when the first capacitor is discharged; and a second capacitor to which electric charge is moved from the first capacitor via the third and fourth switching means when third and fourth switching means are turned on (a third configuration).

More specifically, according to another aspect of the present invention, in a charge pump circuit
that is provided with: a first capacitor; first switching means connected between a first end of the first capacitor and an input voltage input terminal and turned on when the first capacitor is charged; second switching means connected between a second end of the first capacitor and a reference voltage input terminal and turned on when the first capacitor is charged; third switching means connected between the first end of the first capacitor and the reference voltage input terminal or between the first end of the first capacitor and an output voltage output terminal and turned on when the first capacitor is discharged; fourth switching in means connected between the second end of the first capacitor and the output voltage output terminal or between the second end of the first capacitor and the input voltage input terminal and turned on when the first capacitor is discharged; a second capacitor connected between the output voltage output terminal and the reference voltage input terminal; controlling means controlling driving of the first to fourth switching means; first monitoring means connected to the input voltage input terminal to monitor an input voltage; and second monitoring means connected to the output voltage output terminal to monitor an output voltage, and
that produces a desired output voltage from the input voltage by charging and discharging the first capacitor cyclically,
at least one of the first and second switching means is divided into a plurality of divided transistors connected in parallel with one another, and
when the first capacitor is charged, the controlling leans determines which of the plurality of divided transistors to drive based on the result of monitoring by the first and second monitoring means (a fourth configuration).

Alternatively, according to another aspect of the present invention, in a charge pump circuit
that is provided with a voltage step-up unit composed of n-stage (where n≧2) voltage step-up circuits connected one next to another, each voltage step-up circuit provided with: a first capacitor; first switching means connected between a first node and a first end of the first capacitor and turned on when the first capacitor is charged; second switching means connected between a second node and a second end of the first capacitor and turned on when the first capacitor is charged; third switching means connected between a third node and the first end of the first capacitor and turned on when the first capacitor is discharged; and fourth switching means connected between a fourth node and the second end of the first capacitor and turned on when the first capacitor is discharged, wherein either the first node of each of the first to nth voltage step-up circuits is connected to an input voltage input terminal, the second node of the first voltage step-up circuit is connected to a reference voltage input terminal, the second node of each of the second to nth voltage step-up circuits is connected to the fourth node of the preceding voltage step-up circuit, the third node of each of the first to nth voltage step-up circuits is connected to the reference voltage input terminal, and the fourth node of the nth voltage step-up circuit is connected to an output voltage output terminal; or instead the first node of the first voltage step-up circuit is connected to an input voltage input terminal, the first node of each of the second to nth voltage step-up circuits is connected to the third node of the preceding voltage step-up circuit, the second node of each of the first to nth voltage step-up circuits is connected to a reference voltage input terminal, the third node of the nth voltage step-up circuit is connected to an output voltage output terminal, and the fourth node of each of the first to nth voltage step-up circuits is connected to the input voltage input terminal,
that is further provided with: a second capacitor connected between the output voltage output terminal and the reference voltage input terminal; controlling means controlling driving of the first to fourth switching means included in each of the first to nth voltage step-up circuits; first monitoring means connected to the input voltage input terminal to monitor an input voltage; and second monitoring means connected to the output voltage output terminal to monitor an output voltage, and
that produces a desired output voltage from the input voltage by cyclically charging and discharging the first capacitor included in each of the first to nth voltage step-up circuits,
at least one of the first and second switching means included in the first voltage step-up circuit is divided into a plurality of divided transistors connected in parallel with one another, and
when the first capacitor is charged, the controlling means determines which of the plurality of divided transistors to drive based on a result of monitoring by the first and second monitoring means (a fifth configuration).

In the charge pump circuit having any of the second to fifth configurations described above, based on the result of the monitoring by the first and second monitoring means, the controlling means may determine which of the plurality of divided transistors to drive such that if the output voltage has not yet reached a target level, less of the transistors are driven so that the on-state resistance of the current path for charging the first capacitor is increased and that, the higher the input voltage, the higher the on-state resistance, and
if the output voltage has already reached the target level, the on-state resistance is decreased (a sixth configuration).

More specifically, in the charge pump circuit having the sixth configuration described above,
at least one of the first and second switching means may be divided into first, second, and third divided transistors whose on state resistances are so designed that the first transistor has the highest on-state resistance, that the second transistor has the second highest on-state resistance, and that the third transistor has the lowest on-state resistance,
the output logic level of the first monitoring means nay be kept low until the input voltage becomes higher than a first threshold and be turned high when the input voltage becomes higher than the first threshold level, and the output logic level of the second monitoring means may be kept low until the output voltage becomes lower than a second threshold and be turned high when the output voltage becomes lower than the second threshold level, and
the control means may so operate that
when the output logic level of the second monitoring means is low and the output logic level of the first monitoring means is high, the first transistor alone is driven while the second and third transistors are left undriven,
when the output logic levels of the first and second monitoring means are both low, the second transistor alone is driven while the first and third transistors are left undriven,
when the output logic levels of the first and second monitoring means are both high, the first and second transistors are driven while the third transistors is left undriven, and
when the output logic level of the second monitoring means is high and the output logic level of the first monitoring means is low, the first to third transistors are all driven (a seventh configuration).

With any of these configurations, even if the level of the input voltage varies, it is possible to reduce in-rush current at start-up without causing a drop in the output voltage or a loss in efficiency.

In the charge pump circuit having the seventh configuration described above, at least one of the first and second monitoring means may have an input-output response having hysteresis (an eighth configuration). With this configuration, it is possible to avoid oscillation resulting from their output feedback.

In the charge pump circuit having any of the third to fifth configurations described above, the first switching means may be a P-channel MOS field-effect transistor, and the second to fourth switching means may be N-channel MOS field-effect transistors (a ninth configuration).

According to another aspect of the present invention, in a portable appliance including a battery as a power source and a DC/DC converter as means for converting an output of the battery, the portable appliance may be provided with, as the DC/DC converter, the power supply circuit having the first configuration described above or the charge pump circuit having any of the second to fifth configurations described above (a tenth configuration).

With this configuration, it is possible to reduce in-rush current at start-up properly all the time irrespective of the charge level of the battery.

### ADVANTAGES OF THE INVENTION

As described above, with power supply circuits and charge pump circuits according to the present invention, even if the level of the input voltage varies, it is possible to reduce in-rush current at start-up without causing a drop in the output voltage or a loss in efficiency.

### BRIEF DESCRIPTION OF DRAWINGS

FIG. 1 A block diagram showing, as an embodiment of the invention, a cellular phone unit according to the invention.

FIG. 2 A circuit diagram showing an example of the configuration of a negative voltage generation circuit 21.

FIG. 3 A timing chart showing an example of the waveforms of control signals.

FIG. 4 A diagram showing the input-output response of a first and a second detector DET1 and DET2.

FIG. 5 A matrix diagram showing the correlation between detector outputs and whether or not output transistors P1 to P3 are driven.

FIG. 6 A circuit diagram showing an example of the configuration of a positive voltage generation circuit 22.

FIG. 7 A circuit diagram showing modified examples of charge pump circuits according to the invention.

FIG. 8 A circuit diagram showing a conventional example of a charge pump circuit.

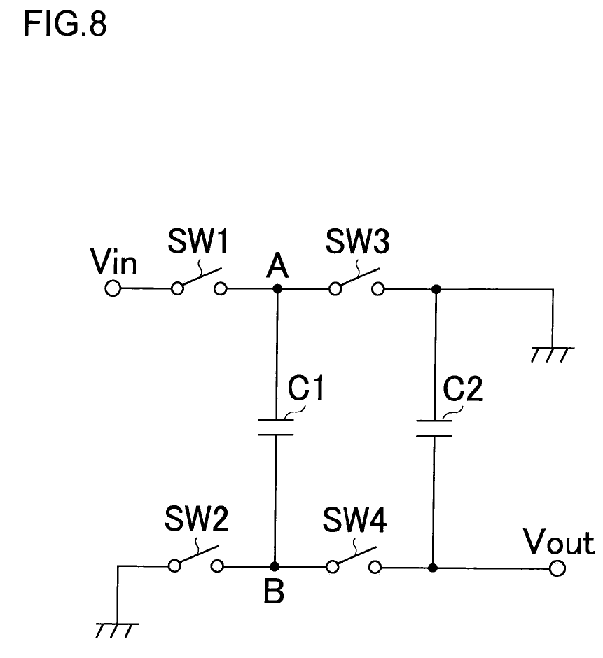

### LIST OF REFERENCE SYMBOLS

1 Battery
2 DC/DC converter
21 Negative Voltage Generation Circuit
22 Positive Voltage Generation Circuit
3 CCD Camera
P1-P3 P-Channel MOS Field-Effect Transistor,
N1-N3 N-Channel MOS Field-Effect Transistors
C1, C2 First and Second Capacitors
DET1, DET2 First and Second Detectors
CNT Controller

### BEST MODE FOR CARRYING OUT THE INVENTION

Hereinafter, the present invention will be described by way of an example in which it is applied to a DC/DC converter that is incorporated in a cellular phone unit to convert the output voltage of a battery to produce a voltage for driving different parts (in particular a CCD—charge-coupled device—camera) of the cellular phone unit.

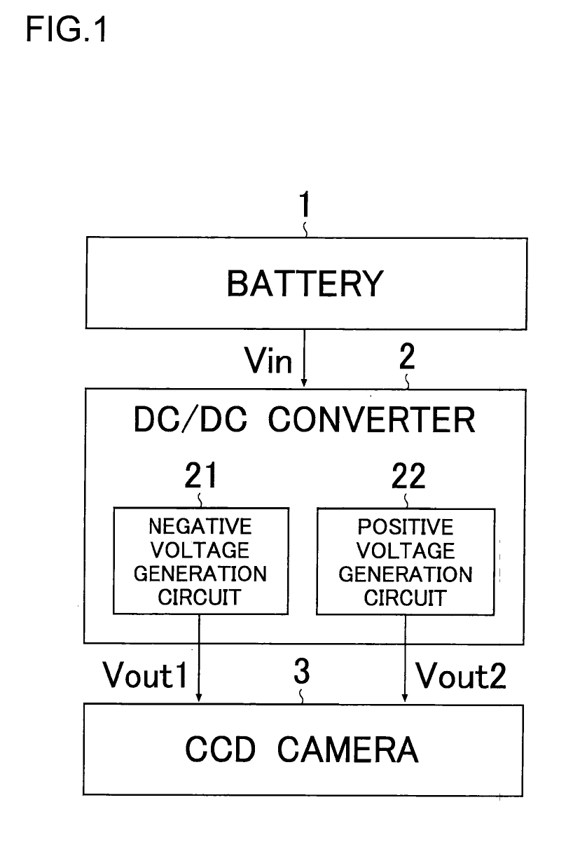

FIG. 1 is a block diagram showing, as an embodiment of the invention, a cellular phone unit according to the invention (in particular its power supply section for a CCD). As shown in the figure, the cellular phone unit this embodiment includes: a battery 1 serving as an electric power source for the entire cellular phone unit; a DC/DC converter 2 serving as means for converting the output of the battery 1; and a CCD camera 3 serving as means by which the cellular phone unit senses images. Needless to say, in addition to the components already mentioned, the cellular phone unit further includes, as means for achieving its essential functions (such as communication functions), a transmission/reception circuit, a loudspeaker, a microphone, a display, an operation panel, a memory, etc.

The CCD camera 3 needs to be driven with a negative drive voltage (e.g., −8 V) and a positive drive voltage (e.g., +15 V). Accordingly, the power supply unit 2 includes a negative voltage generation circuit 21 and a positive voltage generating circuit 22 as means for generating a negative output voltage Vout1 and a positive output voltage Vout2, respectively, from the output voltage Vin of the battery 1.

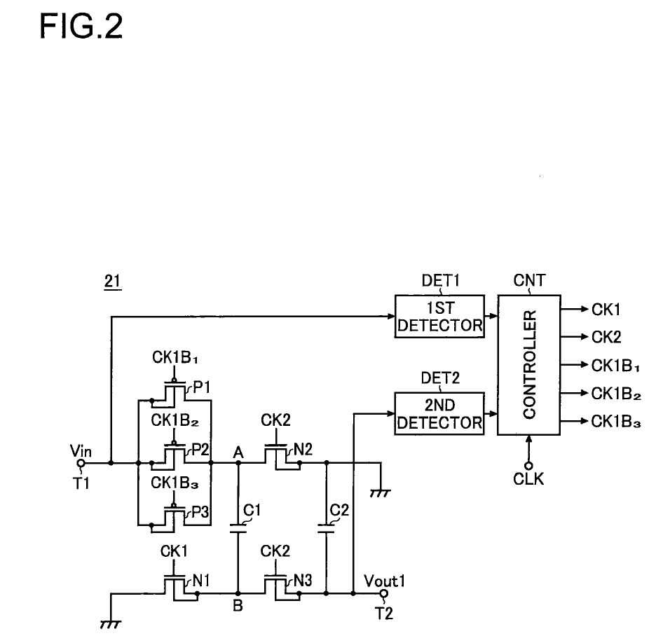

FIG. 2 is a circuit diagram (partly a block diagram) showing an example of the configuration of the negative voltage generation circuit 21. As shown in the figure, the negative voltage generation circuit 21 of this embodiment includes, as switching devices, P-channel MOS (metal-oxide-silicon) field-effect transistors P1 to P3 and N-channel MOS field-effect transistors N1 to N3. Based on control signals CK1, CK1B₁₋₃, and CK2 produced by a controller CNT, these transistors are turned on and off cyclically in such a way that a capacitor C1 is charged with the input voltage Vin (the output voltage of the battery 1) fed in via an input terminal T1, and that the charge voltage across the first capacitor C1 is fed out via an output terminal T2 as a negative output voltage Vout1 (the negative drive voltage for the CCD camera 3). Thus, the negative voltage generation circuit 21 is configured as a negative voltage output charge pump circuit.

The sources of the transistors P1 to P3 are all connected to the input terminal T1. The drains of the transistors P1 to P3 are all connected to a first end (point A) of the first capacitor C1 and to the source of the transistor N2. The gates of the transistors P1 to P3 are connected respectively to different control signal output terminals of the controller CNT to receive the control signals CK1B₁₋₃ respectively. The backgates of the transistors P1 to P3 are connected to their own sources respectively. As will be understood from the foregoing, the transistors P1 to P3 each serve as switching means for turning on and off the connection path between the input terminal T1 and the first capacitor C1 (point A). Put another way, the switching means that is turned on to charge the first capacitor C1 is divided in to transistors P1 to P3 that are connected in parallel with one another; or conversely transistors P1 to P3 that are connected in parallel with one another together form a single multiple-gate transistor.

The source of the transistor N1 is grounded. The drain of the transistor N1 is connected to the second end (point B) of the first capacitor C1 and to the drain of the transistor N3. The gate of the transistor N1 is connected to a control signal output terminal of the controller CNT to receive the control signal CK1. The backgate of the transistor N1 is connected to its own drain. As will be understood from the fore going, the transistor N1 serves as switching means for turning on and off the connection path between ground (a reference voltage application node) and the second end (point B) of the first capacitor C1.

The drain of the transistor N2 is grounded, and is also connected to a first end of a second capacitor C2. The gate of the transistor N2 is connected to a control signal output terminal of the controller CNT to receive the control signal CK2. The backgate of the transistor N2 is connected to its own drain. As will be understood from the foregoing, the transistor N2 serves as switching means for turning on and off the connection path between ground (the reference voltage application node) and the first end (point A) of the first capacitor C1.

The source of the transistor N3 is connected to the second end of the second capacitor C2 and to the output terminal T2. The gate of the transistor N3 is connected to a control signal output terminal of the controller CNT to receive the control signal CK2. The backgate of the transistor N3 is connected to its own source. As will be understood from the fore going, the transistor N3 serves as switching means for turning on and off the connection path between the output terminal T2 and the second end (point B) of the first capacitor C1.

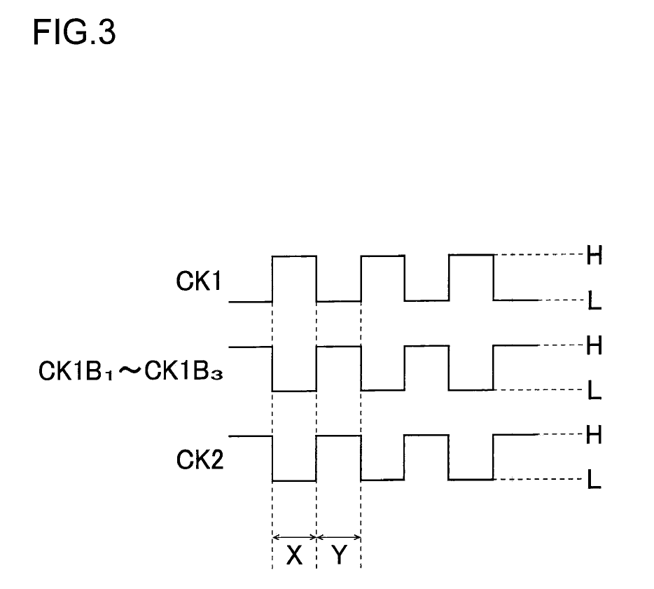

Now, how the negative voltage generation circuit 81 configured as described above operates to output a negative voltage will be specifically described with reference to FIG. 3. FIG. 3 is a timing chart showing an example of the waveforms of the control signals. Although in FIG. 3 the time points at which the logic levels of the signals are turned are shown to exactly coincide, this should be understood to be a simplified representation for easy understanding; in reality, to prevent short-circuiting of the input terminal T1 and the output terminal T2 to ground (i.e., simultaneous turning-on of any of the transistors P1 to P3 and the transistor N2, and simultaneous turning-on of the transistors N1 and N3), the time points at which the logic levels of the control signals CK1 and CK1B₁₋₃ are turned are usually shifted from those at which the logic level of the control signal CK2 is turned.

To generate the negative output voltage Vout1, first the logic level of the control signal CK1 is turned high whereas the logic level of at least one of the control signals CK1B₁₋₃ and the logic level of the control signal CK2 are turned low (and these levels are maintained for period X). Thus, the transistor N1 and at least one of the transistors P1 to P3 are turned on, and the transistors N2 and N3 are turned off. As a result of this switching, the input voltage Vin is applied from the input terminal T1 via at least one of the transistors P1 to P3 to point A, and point B is grounded via the transistor N1. Thus, the first capacitor C1 is charged until the potential difference across it becomes equal to the input voltage Vin.

After completion of the charging of the first capacitor C1, now the logic level of the control signal CK1 is turned low whereas the logic level of the control signals CK1B₁₋₃ and the logic level of the control signal CK2 are turned high (and these levels are maintained for period Y). Thus, the transistor N1 and the transistors P1 to P3 are turned off, and the transistors N2 and N3 are turned on. As a result of this switching, point A is grounded via the transistor N2, and thus the potential at point A falls from the input voltage Vin to the ground potential. Here, since the voltage across the first capacitor C1 is approximately equal to the input voltage Vin as a result of the previous charging, the just mentioned fall in the potential at point A causes the potential at point B to fall from the ground voltage to a negative voltage −Vin. Here, since point B conducts via the transistor N3 to the output terminal T2, the electric charge in the first capacitor C1 moves to the second capacitor C2, and this causes the potential at the output terminal T2 (i.e., the output voltage Vout1) to fall to −Vin.

As periods X and Y recur alternately, the negative voltage generation circuit 21 turns on and off the transistors P1 to P3 and N1 to N3 periodically so that the input voltage Vin fed in via the input terminal T1 is converted into the negative output voltage Vout1 and that this voltage is then fed out via the ground terminal T2.

Here, as described above, in the negative voltage generation circuit 21 of this embodiment, the switching means that is turned on to charge the first capacitor C1 is divided into transistors P1 to P3 that are connected in parallel with one another. With this configuration, when the first capacitor C1 is charged, according to which of the transistors P1 to P3 is driven, the on-state resistance of the current path for the charging of the first capacitor C1 can be varied as desired. Now, as the feature unique to the present invention, the control for selectively driving one or more of the transistors P1 to P3 (control for preventing in-rush current at start-up) will be described in detail.

As shown in FIG. 2 discussed previously, the negative voltage generation circuit 21 of this embodiment includes, in addition to its principal components already mentioned, a first detector DET1 that monitors the input voltage Vin and a second detector DET2 that monitors the output voltage Vout1. Based on the results of the monitoring by the first and second detector DET1 and DET2 (i.e., based on the levels of the input voltage Vin and the output voltage Vout1 relative to each other), the controller CNT determines which of the transistors P1 to P3 to drive.

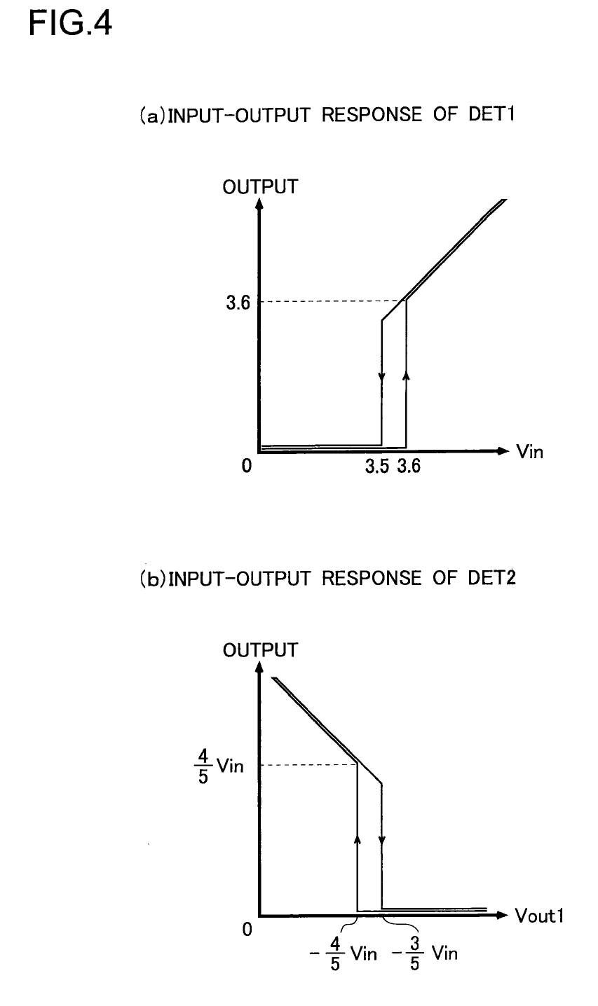

FIG. 4 is a diagram showing the input-output response of each of the first and second detectors DET1 and DET2. In FIG. 4, at (a) is shown the input-output response of the first detector DET1, that is, the correlation between the input voltage Vin (along the horizontal axis) and the detector output (along the vertical axis); at (b) is shown the input-output response of the second detector DET2, that is, the correlation between the output voltage Vout1 (along the horizontal axis) and the detector output (along the vertical axis).

As shown in the figure, the first and second detectors DET1 and DET2 both exhibit an input-output response having hysteresis.

More specifically, the output logic level of the first detector DET1 is kept low until the input voltage Vin becomes higher than a first upper threshold level (in the figure, 3.6 V), and is turned high when the input voltage Vin becomes higher than the first upper threshold level. Once the output logic level of the first detector DET1 turns high, it is kept high unless the input voltage Vin becomes lower than a first lower threshold level (in the figure, 3.5 V), and is turned low when the input voltage Vin becomes lower than the first lower threshold level.

Likewise, the output logic level of the second detector DET2 is kept low until the output voltage Vout1 becomes lower than a second lower threshold level (in the figure, −4/5 Vin), and is turned high when the output voltage Vout1 becomes lower than the second lower threshold level. Once the output logic level of the second detector DET2 turns high, it is kept high unless the output voltage Vout1 becomes higher than a second upper threshold level (in the figure, −3/5 Vin), and is turned low when the output voltage Vout1 becomes higher than the second upper threshold level.

Giving hysteresis to the input-output response of the first and second detectors DET1 and DET2 in this way helps avoid oscillation resulting from their output feedback. The specific threshold levels shown in the figure are merely examples, and any other threshold levels may instead be used so long as the control for selectively driving one or more of the transistors P1 to P3 can be performed properly. The first and second detectors DET1 and DET2 are not limited to those producing a two-level—high or low—output, but may instead be those producing an output whose logic level shifts among three or more levels (e.g., H, M, and L) according to the number of stages into which the switching means is divided that is turned on when the first capacitor C1 is charged.

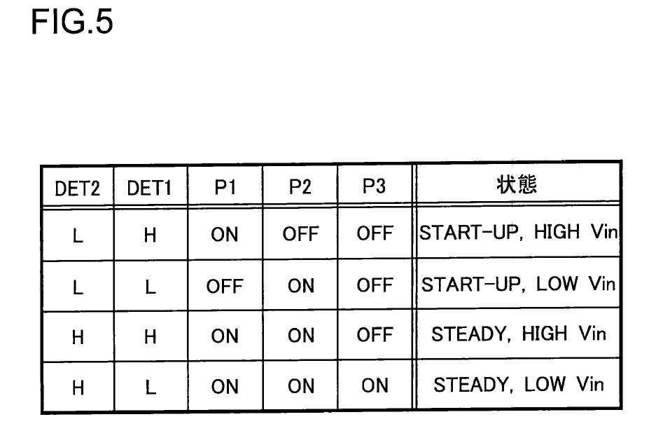

FIG. 5 is a matrix diagram showing the correlation between the detector outputs and whether or not the transistors P1 to P3 are driven, and thus shows the contents of the data table referred to by the controller CNT when it performs the control for selectively driving one or more of the transistors P1 to P3.

The following description assumes that the transistors P1 to P3 are so designed that the transistor P1 has the highest on-state resistance, that the transistor P2 has the second highest on-state resistance, and the transistor P3 has the lowest on-state resistance. It is assumed, for example, that the transistors P1 to P3 are so sized that their W/L ratios are 1000 μm/1 μm, 3000 μm/1 μm, and 11000 μm/1 μm respectively.

First a description will be given of a case where the output logic level of the second detector DET2 is low and the output logic level of the first detector DET1 is high. In this case, in view of the output logic level of the second detector DET2, the controller CNT recognizes that the charge pump circuit is still in the process of start-up and therefore that there is a risk of in-rush current. Moreover, in view of the output logic level of the first detector DET1, the controller CNT recognizes that the charge level of the battery 1 (i.e., the level of the input voltage Vin) is high and therefore that there is much risk of a large in-rush current flowing in. Accordingly, based on the above recognition, the controller CNT so operates as to maximize the on-state resistance of the current path for the charging of the first capacitor C1; to achieve that, the controller CNT produces the control signals CK1B₁₋₃ such that, of the transistors P1 to P3, only the transistor P1—the one having the smallest W/L ratio (i.e., the highest on-state resistance)—is driven while the other transistors P2 and P3 are left undriven (kept off). In this operation state, the negative voltage generation circuit 21 can reduce in-rush current at start-up.

Next a description will be given of a case where the output logic levels of the first and second detectors DET1 and DET2 are both low. In this case, in view of the output logic level of the second detector DET2, the controller CNT recognizes that the charge pump circuit is still in the process of start-up and therefore that there is a risk of in-rush current. Moreover, in view of the output logic level of the first detector DET1, the controller CNT recognizes that the charge level of the battery 1 (i.e., the level of the input voltage Vin) is low and therefore that there is little risk of a large in-rush current flowing in. Accordingly, based on the above recognition, the controller CNT so operates as to increase to a sufficiently but not unduly high level the on-state resistance of the current path for the charging of the first capacitor C1; to achieve that, the controller CNT produces the control signals CK1B₁₋₃ such that, of the transistors P1 to P3, only the transistor P2—the one having the second smallest W/L ratio (i.e., the second highest on-state resistance)—is driven while the other transistors P1 and P3 are left undriven (kept off). In this operation state, the negative voltage generation circuit 21 can reduce in-rush current at start-up without causing a shortage in the output voltage Vout or a loss in efficiency even when the battery is battery is almost depleted.

Next a description will be given of a case where the output logic levels of the first and second detectors DET1 and DET2 are both high. In this case, in view of the output logic level of the second detector DET2, the controller CNT recognizes that the charge pump circuit is in the steady state and therefore that there is little risk of in-rush current. Moreover, in view of the output logic level of the first detector DET1, the controller CNT recognizes that the source voltage of the transistors P1 to P3 (i.e., the input voltage Vin) is sufficiently high and therefore that their on-state resistances are all comparatively low. Accordingly, based on the above recognition, the controller CNT so operates as to produce the control signals CK1B₁₋₃ such that the transistors P1 and P2 are driven while the transistor P3 are left undriven (kept off). In this operation state, the negative voltage generation circuit 21 can, instead of unconditionally driving all the transistors P1 to P3 and thereby unnecessarily decreasing the on-state resistance of the current path for the charging of the first capacitor C1, decrease it appropriately to a predetermined target level. In this way, it is possible to reduce the output impedance of the charge pump circuit in the steady state to a target level without causing a loss in efficiency.

Next a description will be given of a case where the output logic level of the second detector DET2 is high and the output logic level of the first detector DET1 is low. In this case, in view of the output logic level of the second detector DET2, the controller CNT recognizes that the charge pump circuit is in the steady state and therefore that there is little risk of in-rush current. Moreover, in view of the output logic level of the first detector DET1, the controller CNT recognizes that the source voltage of the transistors P1 to P3 (i.e., the input voltage Vin) is low and therefore that their on-state resistances are all comparatively high. Accordingly, based on the above recognition, the controller CNT so operates as to produce the control signals CK1B₁₋₃ such that all the transistors P1 to P3 are driven. In this operation state, the negative voltage generation circuit 21 can, by minimizing the on-state resistance of the current path for the charging of the first capacitor C1, reduce the output impedance of the charge pump circuit in the steady state to a target level even when the battery 1 is almost depleted.

The above-described control for selectively driving one or more transistors is merely an example; it may be modified to suit the actual sizes of the transistors P1 to P3 and the actual threshold levels of the first and second detectors DET1 and DET2 so that, as the case may be, only the transistor P2 or P3 is driven, or the transistors P1 and P3 are driven simultaneously.

As described above, in the negative voltage generation circuit 21 of this embodiment, there are provided, as switching means that is turned on when the first capacitor C1 is charged, transistors P1 to P3 that are connected in parallel with each other between the first end of the first capacitor C1 and the input terminal T1, and, when the first capacitor C1 is charged, the controller CNT determines which of the transistors P1 to P3 to drive based on the results of the monitoring of the input and output voltages by the first and second detectors DET1 and DET2.

With the transistors P1 to P3 divided as described above, their gate voltages can be controlled with separate inverters respectively. Thus, as distinct from conventional methods for preventing in-rush current, it is possible to achieve low-impedance driving irrespective of whether the transistors are individually on or off. Also in a case where an attempt is made to reduce the output impedance of the charge pump circuit by giving the transistors high W/L ratios, with the transistors P1 to P3 divided, it is possible to reduce the gate capacitances of the individual transistors. Thus, as compared with conventional methods for preventing in-rush current, it is possible to obtain greatly improved conversion efficiency, and this makes application to charge pump circuits having low output impedances possible. Moreover, with the configuration described above, it is also possible to reduce delays in switching, and this makes adaptation to higher switching frequencies possible.

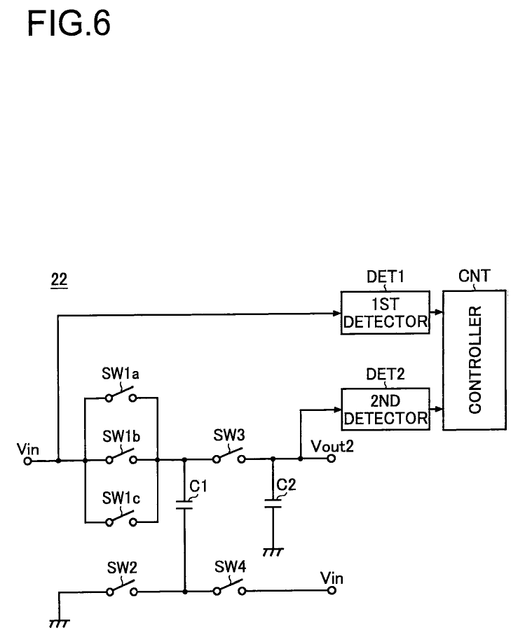

Although the embodiment described above deals with, as an example, the configuration and operation of a negative voltage generation circuit 21, this is in no way meant to limit the configuration of the present invention; the invention can also be applied to a positive voltage generating circuit 22 (positive voltage output charge pump circuit (see FIG. 6). In that case, separate controllers CNT may be provided one for each of the negative and positive voltage generation circuits 21 and 22, or a single controller CNT may be provided that is shared between them.

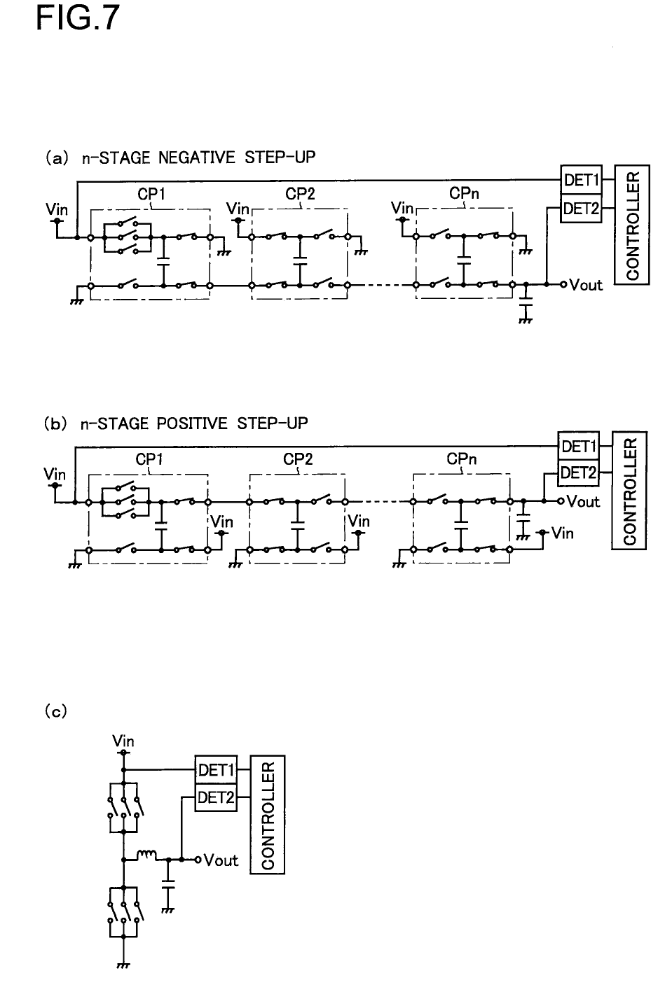

The present invention finds wide application in charge pump circuits having a first to an nth voltage step-up circuit CP1 to CPn (where n≧2) connected one next to another (see FIGS. 7(a) and (b)), and also in power supply circuits (see FIG. 7(c)) other than charge pump circuits.

The present invention may be practiced in any manner other than specifically described by way of an embodiment above, and many variations and modifications are possible within the spirit of the invention.

For example, although the embodiment described above deals with an example where, of all the switching devices constituting the charge pump circuit, those used as switching means for turning on and off the connection path between the input terminal T1 and the first end (point A) of the first capacitor C1 are realized with P-channel MOS field-effect transistors and those used as other switching means are realized with N-channel MOS field-effect transistors, this is in no way meant to limit the invention; the channel properties of the individual switching devices may be designed appropriately so that the desired characteristics (such as withstand voltage characteristics) are obtained in the charge pump circuit as a whole.

Although the embodiment described above deals with an example where the switching means that is turned on when the first capacitor C1 is charged includes switching means connected on the power source side of the first transistor C1 and this switching means is divided into a plurality of switching devices, this is in no way meant to limit the invention; the switching means connected on the ground side of the first transistor may instead be divided into a plurality of switching devices, or both may be divided into a plurality of switching devices.

### INDUSTRIAL APPLICABILITY

The present invention is useful in reducing in-rush current in charge pump circuits, and is particularly suitable for DC/DC converts used as battery output converting means in portable appliances.

1. A power supply circuit comprising:
first switching means connected between a first end of a capacitor and an input voltage input terminal and operable to be turned on when the capacitor is charged; and/or
second switching means connected between a second end of the capacitor and a reference voltage input terminal and operable to be turned on when the capacitor is charged,
the power supply circuit operable to produce a specified output voltage from an input voltage by charging and discharging the capacitor cyclically,
wherein at least one of the first and second switching means comprises a plurality of divided transistors connected in parallel with one another and having different driving capacities and is operable to to yield a minimum driving capacity when the input voltage is high and the output voltage is low and a maximum driving capacity when the input voltage is low and the output voltage is stable.

2. A charge pump circuit comprising:
first switching means connected between a first end of a first capacitor and an input voltage input terminal and operable to be turned on when the capacitor is charged;
second switching means connected between a second end of the first capacitor and a reference voltage input terminal and operable to be turned on when the capacitor is charged;
controlling means to control driving of the first and second switching means;
first monitoring means to monitor an input voltage; and
second monitoring means to monitor an output voltage,
the charge pump circuit for producing a specified output voltage from the input voltage by charging and discharging the first capacitor cyclically,
wherein at least one of the first and second switching means is divided into a plurality of divided transistors connected in parallel with one another, and
wherein the charge pump is operable so that when the first capacitor is charged, the controlling means determines which of the plurality of divided transistors to drive based on a result of monitoring by the first and second monitoring means.

3. The charge pump circuit of claim 2, further comprising:
third and fourth switching means operable to be turned on when the first capacitor is discharged; and
a second capacitor to which electric charge is moved from the first capacitor via the third and fourth switching means when third and fourth switching means are turned on.

4. A charge pump circuit comprising:
a first capacitor;
first switching means connected between a first end of the first capacitor and an input voltage input terminal and operable to be turned on when the first capacitor is charged;
second switching means connected between a second end of the first capacitor and a reference voltage input terminal and operable to be turned on when the first capacitor is charged;
third switching means connected between the first end of the first capacitor and the reference voltage input terminal or between the first end of the first capacitor and an output voltage output terminal and operable to be turned on when the first capacitor is discharged;
fourth switching means connected between the second end of the first capacitor and the output voltage output terminal or between the second end of the first capacitor and the input voltage input terminal and operable to be turned on when the first capacitor is discharged;
a second capacitor connected between the output voltage output terminal and the reference voltage input terminal;
controlling means to control driving of the first to fourth switching means;
first monitoring means connected to the input voltage input terminal to monitor an input voltage; and
second monitoring means connected to the output voltage output terminal to monitor an output voltage,
the charge pump circuit for producing a specified output voltage from the input voltage by charging and discharging the first capacitor cyclically,
wherein at least one of the first and second switching means is divided into a plurality of divided transistors connected in parallel with one another, and
wherein the charge pump circuit is operable so that when the first capacitor is charged, the controlling means determines which of the plurality of divided transistors to drive based on a result of monitoring by the first and second monitoring means.

5. A charge pump circuit comprising:
a voltage step-up unit composed of n-stage (where n≧9) voltage step-up circuits connected one next to another, each voltage step-up circuit comprising:
a first capacitor;
first switching means connected between a first node and a first end of the first capacitor and operable to be turned on when the first capacitor is charged;
second switching means connected between a second node and a second end of the first capacitor and operable to be turned on when the first capacitor is charged;
third switching means connected between a third node and the first end of the first capacitor and operable to be turned on when the first capacitor is discharge; and
fourth switching means connected between a fourth node and the second end of the first capacitor and operable to be turned on when the first capacitor is discharged,
wherein either
the first node of each of the first to nth voltage step-up circuits is connected to an input voltage input terminal,
the second node of the first voltage step-up circuit is connected to a reference voltage input terminal,
the second node of each of the second to nth voltage step-up circuits is connected to the fourth node of the preceding voltage step-up circuit,
the third node of each of the first to nth voltage step-up circuits is connected to the reference voltage input terminal, and
the fourth node of the nth voltage step-up circuit is connected to an output voltage output terminal, or
the first node of the first voltage step-up circuit is connected to an input voltage input terminal,
the first node of each of the second to nth voltage step-up circuits is connected to the third node of the preceding voltage step-up circuit,
the second node of each of the first to nth voltage step-up circuits is connected to a reference voltage input terminal,
the third node of the nth voltage step-up circuit is connected to an output voltage output terminal, and
the fourth node of each of the first to nth voltage step-up circuits is connected to the input voltage input terminal;
a second capacitor connected between the output voltage output terminal and the reference voltage input terminal;
controlling means to control driving of the first to fourth switching means included in each of the first to nth voltage step-up circuits;
first monitoring means connected to the input voltage input terminal to monitor an input voltage; and
second monitoring means connected to the output voltage output terminal to monitor an output voltage,
the charge pump circuit operable to produce a specified output voltage from the input voltage by cyclically charging and discharging the first capacitor included in each of the first to nth voltage step-up circuits,
wherein at least one of the first and second switching means included in the first voltage step-up circuit is divided into a plurality of divided transistors connected in parallel with one another, and
wherein the charge pump circuit is operable so that when the first capacitor is charged, the controlling means determines which of the plurality of divided transistors to drive based on a result of monitoring by the first and second monitoring means.

6. The charge pump circuit of claim 2
wherein, based on the result of the monitoring by the first and second monitoring means, the controlling means is operable to determine which of the plurality of divided transistors to drive such that
if the output voltage has not yet reached a target level, fewer of the transistors are driven so that an on-state resistance of a current path for charging the first capacitor is increased and that, the higher the input voltage, the higher the on-state resistance, and
if the output voltage has already reached the target level, the on-state resistance is decreased.

7. The charge pump circuit of claim 6,
wherein
at least one of the first and second switching means is divided into first, second, and third divided transistors whose on-state resistances are operable so that the first transistor has a highest on-state resistance, the second transistor has a second highest on-state resistance, and the third transistor has a lowest on-state resistance,
an output logic level of the first monitoring means is kept low until the input voltage becomes higher than a first threshold and is turned high when the input voltage becomes higher than the first threshold level, and an output logic level of the second monitoring means is kept low until the output voltage becomes lower than a second threshold and is turned high when the output voltage becomes lower than the second threshold level, and
the control means is operable so that
when the output logic level of the second monitoring means is low and the output logic level of the first monitoring means is high, the first transistor alone is driven while the second and third transistors are left undriven,
when the output logic levels of the first and second monitoring means are both low, the second transistor alone is driven while the first and third transistors are left undriven,
when the output logic levels of the first and second monitoring means are both high, the first and second transistors are driven while the third transistors is left undriven, and
when the output logic level of the second monitoring means is high and the output logic level of the first monitoring means is low, the first to third transistors are all driven.

8. The charge pump circuit of claim 7, wherein at least one of the first and second monitoring means has an input-output response having hysteresis.

9. The charge pump circuit of claim 3, wherein the first switching means is a P-channel MOS field-effect transistor, and the second to fourth switching means are N-channel MOS field-effect transistors.

10. A portable appliance including a battery as a power source and a DC/DC converter as means for converting an output of the battery,
wherein the portable appliance comprises, as the DC/DC converter, the power supply circuit of claim 1.

11. The charge pump circuit of claim 3 wherein, based on the result of the monitoring by the first and second monitoring means, the controlling means is operable to determine which of the plurality of divided transistors to drive such that
if the output voltage has not yet reached a target level, fewer of the transistors are driven so that an on-state resistance of a current path for charging the first capacitor is increased and that, the higher the input voltage, the higher the on-state resistance, and
if the output voltage has already reached the target level, the on-state resistance is decreased.

12. The charge pump circuit of claim 11,
wherein
at least one of the first and second switching means is divided into first, second, and third divided transistors whose on-state resistances are operable so that the first transistor has a highest on-state resistance, the second transistor has a second highest on-state resistance, and the third transistor has a lowest on-state resistance,
an output logic level of the first monitoring means is kept low until the input voltage becomes higher than a first threshold and is turned high when the input voltage becomes higher than the first threshold level, and an output logic level of the second monitoring means is kept low until the output voltage becomes lower than a second threshold and is turned high when the output voltage becomes lower than the second threshold level, and
the control means is operable so that
when the output logic level of the second monitoring means is low and the output logic level of the first monitoring means is high, the first transistor alone is driven while the second and third transistors are left undriven,
when the output logic levels of the first and second monitoring means are both low, the second transistor alone is driven while the first and third transistors are left undriven,
when the output logic levels of the first and second monitoring means are both high, the first and second transistors are driven while the third transistors is left undriven, and
when the output logic level of the second monitoring means is high and the output logic level of the first monitoring means is low, the first to third transistors are all driven.

13. The charge pump circuit of claim 12, wherein at least one of the first and second monitoring means has an input-output response having hysteresis.

14. The charge pump circuit of claim 4 wherein, based on the result of the monitoring by the first and second monitoring means, the controlling means is operable to determine which of the plurality of divided transistors to drive such that
if the output voltage has not yet reached a target level, fewer of the transistors are driven so that an on-state resistance of a current path for charging the first capacitor is increased and that, the higher the input voltage, the higher the on-state resistance, and
if the output voltage has already reached the target level, the on-state resistance is decreased.

15. The charge pump circuit of claim 14,
wherein
at least one of the first and second switching means is divided into first, second, and third divided transistors whose on-state resistances are operable so that the first transistor has a highest on-state resistance, the second transistor has a second highest on-state resistance, and the third transistor has a lowest on-state resistance,
an output logic level of the first monitoring means is kept low until the input voltage becomes higher than a first threshold and is turned high when the input voltage becomes higher than the first threshold level, and an output logic level of the second monitoring means is kept low until the output voltage becomes lower than a second threshold and is turned high when the output voltage becomes lower than the second threshold level, and
the control means is operable so that
when the output logic level of the second monitoring means is low and the output logic level of the first monitoring means is high, the first transistor alone is driven while the second and third transistors are left undriven,
when the output logic levels of the first and second monitoring means are both low, the second transistor alone is driven while the first and third transistors are left undriven,
when the output logic levels of the first and second monitoring means are both high, the first and second transistors are driven while the third transistors is left undriven, and
when the output logic level of the second monitoring means is high and the output logic level of the first monitoring means is low, the first to third transistors are all driven.

16. The charge pump circuit of claim 15, wherein at least one of the first and second monitoring means has an input-output response having hysteresis.

17. The charge pump circuit of claim 5 wherein, based on the result of the monitoring by the first and second monitoring means, the controlling means is operable to determine which of the plurality of divided transistors to drive such that
if the output voltage has not yet reached a target level, fewer of the transistors are driven so that an on-state resistance of a current path for charging the first capacitor is increased and that, the higher the input voltage, the higher the on-state resistance, and
if the output voltage has already reached the target level, the on-state resistance is decreased.

18. The charge pump circuit of claim 17,
wherein
at least one of the first and second switching means is divided into first, second, and third divided transistors whose on-state resistances are operable so that the first transistor has a highest on-state resistance, the second transistor has a second highest on-state resistance, and the third transistor has a lowest on-state resistance,
an output logic level of the first monitoring means is kept low until the input voltage becomes higher than a first threshold and is turned high when the input voltage becomes higher than the first threshold level, and an output logic level of the second monitoring means is kept low until the output voltage becomes lower than a second threshold and is turned high when the output voltage becomes lower than the second threshold level, and
the control means is operable so that
when the output logic level of the second monitoring means is low and the output logic level of the first monitoring means is high, the first transistor alone is driven while the second and third transistors are left undriven,
when the output logic levels of the first and second monitoring means are both low, the second transistor alone is driven while the first and third transistors are left undriven,
when the output logic levels of the first and second monitoring means are both high, the first and second transistors are driven while the third transistors is left undriven, and
when the output logic level of the second monitoring means is high and the output logic level of the first monitoring means is low, the first to third transistors are all driven.

19. The charge pump circuit of claim 18, wherein at least one of the first and second monitoring means has an input-output response having hysteresis.

20. The charge pump circuit of claim 4 wherein the first switching means is a P-channel MOS field-effect transistor, and the second to fourth switching means are N-channel MOS field-effect transistors.

21. The charge pump circuit of claim 5 wherein the first switching means is a P-channel MOS field-effect transistor, and the second to fourth switching means are N-channel MOS field-effect transistors.

22. A portable appliance including a battery as a power source and a DC/DC converter as means for converting an output of the battery,
wherein the portable appliance comprises, as the DC/DC converter, the charge pump circuit of claim 2.

23. A portable appliance including a battery as a power source and a DC/DC converter as means for converting an output of the battery,
wherein the portable appliance comprises, as the DC/DC converter, the charge pump circuit of claim 3.

24. A portable appliance including a battery as a power source and a DC/DC converter as means for converting an output of the battery,
wherein the portable appliance comprises, as the DC/DC converter, the charge pump circuit of claim 5.
